(19) United States
(12) Patent Application Publication
(10) Pub. No.: US 2008/0111522 A1
(43) Pub. Date: May 15, 2008

(54) METHOD AND SYSTEM FOR CHARGING ELECTRONIC DEVICES

(75) Inventors: Russell L. Simpson, Miami, FL (US); John M. Burgan, North Palm Beach, FL (US); Joseph Patino, Pembroke Pines, FL (US); Marco Pulido, Miramar, FL (US)

Correspondence Address: MOTOROLA, INC, 1303 EAST ALGONQUIN ROAD, IL01/3RD, SCHAUMBURG, IL, 60196, US

(73) Assignee: Motorola, Inc., Schaumburg, IL (US)

(21) Appl. No.: 11/673,692

(22) Filed: Feb. 12, 2007

Related U.S. Application Data
(60) Provisional application No. 60/865,891, filed on Nov. 15, 2006.

(51) Int. Cl. H02J 7/00; H01M 10/44

(52) U.S. Cl. 320/162

(57) ABSTRACT

A method and system for charging an electronic device (104) is provided. The method includes negotiating a first current supply (304) from a first charging port. The first charging port is one of a plurality of charging ports (106, 108, 110, 112 and 114) present on a current-supplying device (102). Further, the method includes negotiating a second current supply (306) from a second charging port, the second charging port is one of the plurality of charging ports (106, 108, 110, 112 and 114). Furthermore, the method includes combining the first current supply and the second current supply (308) to provide a combined current supply for charging the battery of the electronic device.

### RELATED APPLICATION

This application is related to Provisional Application Ser. No. 60/865,891, filed Nov. 15, 2006. Applicants claim priority thereof.

### FIELD OF THE INVENTION

This invention relates in general to electronic devices, and more specifically, to a method and system for charging electronic devices.

### BACKGROUND OF THE INVENTION

Electronic devices require power to perform a wide variety of functions. For example, they can be used to play audio files, send messages, make audio and/or video calls and browse the Internet. Examples of electronic devices include, but are not limited to, portable music players, personal digital assistants (PDAs), IPODs™, mobile phones and laptops. A number of electronic devices have a rechargeable unit, such as a rechargeable battery. Examples of rechargeable batteries can be Nickel Metal Hydride batteries, Nickel Cadmium batteries, Lithium Ion batteries, Sealed Lead Acid, etc. Rechargeable units need to be charged by using a power supply or a charging device. The charging device can derive the power required for charging the rechargeable unit from an external power-supplying unit. The external power-supplying unit can be a wall socket, a port of a desktop, a port of a laptop, and the like. The charging device can be an independent unit or can be integrated with the electronic devices.

A port on an electronic device can be used to supply current, with the electronic device acting as the power-supply unit. One of the most commonly available ports is a Universal Serial Bus (USB) port on a desktop or a laptop. Moreover, the USB port has its own voltage-stabilizing circuit and hence provides protection against potentially dangerous voltage spikes. However, a charging port such as the USB port has some disadvantages. Firstly, the charging port can provide only a limited amount of current until negotiations for additional power are made with the electronic device harboring the charging port. For example, in the case of the USB port, only 100 MA of current can be extracted, prior to any negotiations with the electronic device harboring the USB port. Further, even post negotiation, a low maximum current supply can be extracted from the electronic device. For example, post negotiation, the electronic device may provide only a maximum of 500 mA of current through the USB port. Also, there maybe a greater current requirement for rapidly charging the rechargeable unit.

### BRIEF DESCRIPTION OF THE DRAWINGS

The present invention is illustrated by way of example, and not limitation, in the accompanying figures, in which like references indicate similar elements, and in which:

FIG. 1 illustrates a current-supplying device and an electronic device, where various embodiments of the present invention can be practiced;

FIG. 2 is a block diagram of a charging device, in accordance with an embodiment of the present invention;

FIG. 3 is a flow diagram illustrating a method for charging an electronic device by means of a charging device, in accordance with various embodiments of the present invention;

FIG. 4 is a flow diagram illustrating a method for charging an electronic device by means of a charging device by using a USB port, in accordance with an embodiment of the present invention; and

FIG. 5 is a flow diagram illustrating a detailed method for charging the electronic device by means of the charging device, in accordance with another embodiment of the present invention.

Skilled artisans will appreciate that elements in the figures are illustrated for simplicity and clarity and have not necessarily been drawn to scale. For example, the dimensions of some of the elements in the figures may be exaggerated, relative to other elements, to help in improving an understanding of the embodiments of the present invention.

### DETAILED DESCRIPTION OF THE EMBODIMENTS

Before describing in detail the particular method and system for charging electronic devices, in accordance with the present invention, it should be observed that the present invention resides primarily in combinations of method steps and apparatus components related to the method and system for charging electronic devices. Accordingly, the apparatus components and method steps have been represented, where appropriate, by conventional symbols in the drawings, showing only those specific details that are pertinent for an understanding of the present invention, so as not to obscure the disclosure with details that will be readily apparent to those with ordinary skill in the art, having the benefit of the description herein.

The terms such as ‘comprises,’ ‘comprising,’ ‘includes,’ ‘including,’ or any other variation thereof, are intended to cover a non-exclusive inclusion, such that a process, method, article, or apparatus that comprises a list of elements does not include only those elements but may include other elements not expressly listed or inherent to such a process, method, article or apparatus. An element preceded by ‘comprises . . . a’, does not, without more constraints, preclude the existence of additional identical elements in the process, method, article or apparatus that comprises the element. The term ‘another,’ as used herein, is defined as at least a second or more. The terms ‘including’ and/or ‘having,’ as used herein, are defined as comprising. The term ‘coupled,’ as used herein with reference to electro-optical technology, is defined as connected, although not necessarily directly or mechanically. The term ‘program,’ as used herein, is defined as a sequence of instructions designed for execution on a computer system. A ‘program’ or ‘computer program’ may include a subroutine, a function, a procedure, an object method, an object implementation, an executable application, an applet, a servlet, a source code, an object code, a shared library/dynamic load library and/or other sequence of instructions designed for execution on a computer system.

A method for charging a battery of an electronic device by means of a charging device is provided, in accordance with various embodiments of the present invention. The charging device is connected to a current-supplying device, which includes a plurality of charging ports. The method includes negotiating a first current supply from a first charging port of the plurality of the charging ports. Further, the method includes negotiating a second current supply from a second charging port of the plurality of charging ports. The negotiations for the second current supply from the second charging port are based on the first current supply from the first charging port. Moreover, the method includes combining the first current supply and the second current supply to provide a combined current supply for charging the battery of the electronic device.

A method for charging a battery of an electronic device is provided, in accordance with an embodiment of the present invention. The charging device is connected to a current-supplying device, which includes a plurality of Universal Serial Bus (USB) ports. The method includes negotiating a first current supply from a first USB port. The first USB port is one of the plurality of USB ports. Further, the method includes negotiating a second current supply from a second USB port of the plurality of USB ports. The negotiations for the second current supply from the second USB port are based on the first current supply from the first USB port. Moreover, the method includes combining the first current supply and the second current supply to provide a combined current supply for charging the battery of the electronic device.

A charging device for charging a battery of an electronic device is provided, in accordance with various embodiments of the present invention. The charging device includes a plurality of input connectors for connecting a current-supplying device to the charging device. Further, the charging device includes a microcontroller that is capable of negotiating a second current supply from each one of a plurality of charging ports. The charging ports are present in the current-supplying device, based on a first current supply from a first set of charging ports of the plurality of charging ports. Furthermore, the charging device includes an output connector for connecting the microcontroller to the electronic device. The output connector for supplying a combined current supply to the electronic device by combining the first and second current supplies.

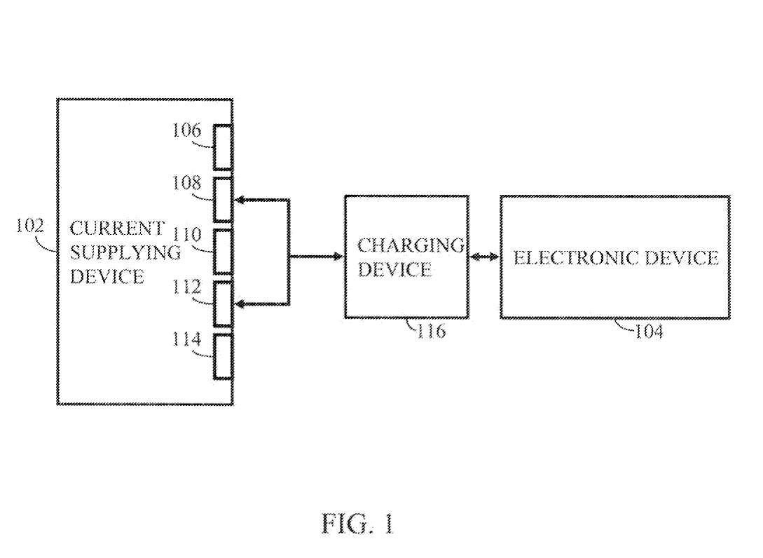

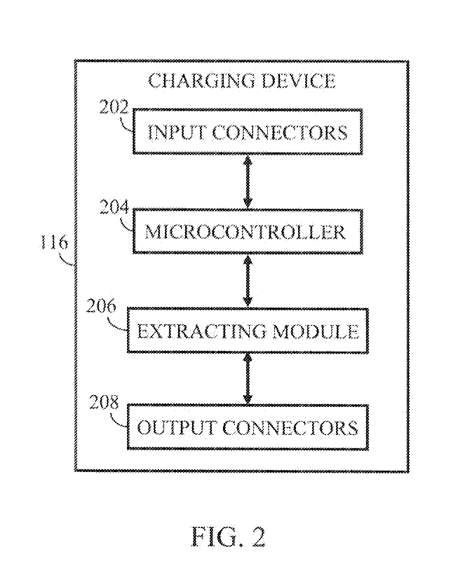

FIG. 1 illustrates a current-supplying device 102 and an electronic device 104, where various embodiments of the present invention can be practiced. The current-supplying device 102 is used to charge the electronic device 104 and is capable of fulfilling the current requirement of the electronic device 104. The electronic device 104 can be used to exchange information and data with other electronic devices through a communication network. Further, the electronic device 104 can also be a portable device such as a portable media player, a portable storage device, etc. Examples of the electronic device 104 can be, but are not limited to, a portable music player, a personal digital assistant (PDA), an IPOD™, a mobile phone, etc. The electronic device 104 is connected to the current-supplying device 102 for charging the battery of the electronic device 104, so that the electronic device 104 gets enough power supply to perform various operations. The current-supplying device 102 can be a direct power supply or it can be another device that can supply the required power to the electronic device 104. Examples of the current-supplying device 102 can be, a laptop, a desktop, a direct AC power supply, and so forth. Further, the current-supplying device 102 has a plurality of charging ports 106, 108, 110, 112 and 114 for charging the electronic device 104. The current-supplying device 102 can have various types of charging ports such as a Universal Serial Bus (USB) port, a serial port, a parallel port, and the like. The plurality of charging ports 106, 108, 110, 112 and 114 can be used to transfer information required to negotiate a current supply with the current-supplying device 102. The electronic device 104 can be charged by using a charging device 116, which acts as an interface between the current-supplying device 102 and the electronic device 104. The charging device 116 can also perform current negotiations with the current-supplying device 102 if the current requirement of the electronic device 104 increases when the electronic device 104 is being charged by the current supplying device 102. The current negotiations that take place between the electronic device 104 and the current-supplying device 102 are explained in further detail in conjunction with FIG. 2. Further, the plurality of charging ports 106, 108, 110, 112 and 114 can be used to supply current to the charging device 116. Examples of the charging device 116 include a laptop charger, a mobile phone charger, a rechargeable battery charger, and the like.

FIG. 2 is a block diagram of the charging device 116, in accordance with various embodiments of the present invention. The block diagram is a schematic representation describing the various components of the charging device 116 and the functionalities associated with the components of the charging device 116. The charging device 116 is used to charge the electronic device 104 and includes a plurality of input connectors 202, a microcontroller 204, an extracting module 206, and an output connector 208.

The plurality of input connectors 202 connects the charging device 116 to the current-supplying device 102. The plurality of input connectors 202 connects to the current-supplying device 102 by using one or more of the plurality of charging ports 106, 108, 110, 112 and 114 present on the current-supplying device 102. Examples of the plurality of input connectors 202 include USB connectors such as a Series “A” plug, Mini-B receptacle connectors, serial port connectors, parallel port connectors, and the like. The plurality of input connectors 202 are used for draining current from the current-supplying device 102. Further, the plurality of input connectors 202 can exchange data or information with the microcontroller 204. The data or information exchanged between the plurality of input connectors 202 and the microcontroller 204 may correspond to negotiations for current extraction from one or more of the plurality of charging ports 106, 108, 110, 112 and 114.

The microcontroller 204 can manage the logical functions of the charging device 116 and negotiates a first current supply with a first charging port of the plurality of charging ports 106, 108, 110, 112 and 114. The microcontroller 204 uses the extracting module 206 to extract the first current supply from the first charging port. For an embodiment of the present invention, the charging device 116 can include a detector for detecting whether the plurality of input connectors 202 is connected to the plurality of charging ports 106, 108, 110, 112 and 114. The detector detects a second charging port post extraction of the first current supply from the first charging port of the plurality of charging ports 106, 108, 110, 112 and 114. The detector detects the second charging port, based on the presence of a predefined voltage potential at the second charging port. For example, a voltage of 5 volts is present across the USB port in a standard USB port. The detector can detect the 5 volts at the second USB port, after which the microcontroller 204 can start negotiating for the second current supply with the current-supplying unit 102. The microcontroller 204 can also interact with the electronic device 104 by using a communicating module and the output connector 208. The communicating module is used to communicate the charging condition of the charging device 116 to the electronic device 104 by using the output connector 208. The charging condition is based on a combined current supply from the microcontroller 204 to the electronic device 104, to charge the battery of the electronic device 104. The output connector 208 supplies the combined current supply from the current-supplying device 102 to the electronic device 104 for charging the battery of the electronic device 104.

After the negotiations for current supply are completed, the microcontroller 204 connects one of the plurality of charging ports with the electronic device 104. The one of the plurality of charging ports connected to the electronic device 104 can be used for information exchange between the current-supplying device 102 and the electronic device 104. For example, an IPOD™ can be charged by using a USB port on a laptop and at the same time, information or data can be transferred between the IPOD™ and the laptop.

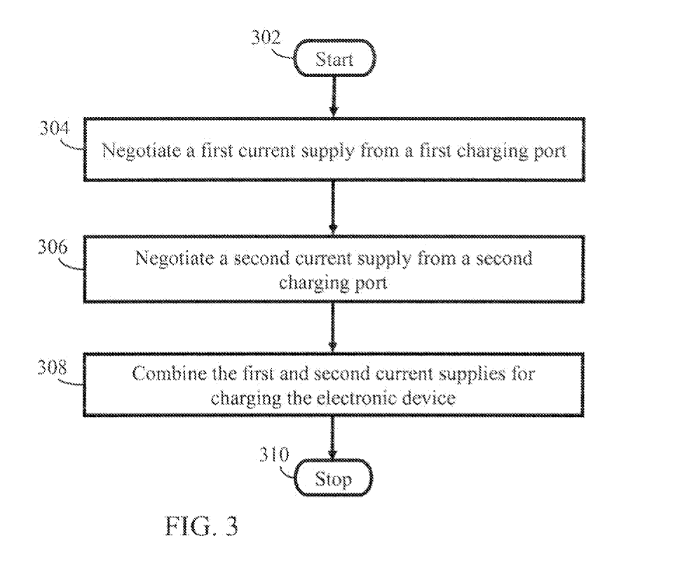

FIG. 3 is a flow diagram illustrating a method for charging the electronic device 104 by means of the charging device 116, in accordance with various embodiments of the present invention. The current-supplying device 102 is used to provide current to the electronic device 104 through the charging device 116. The method is initiated at step 302. At step 304, negotiations for a first current supply from a first charging port are initiated. Negotiations for the first current supply from the first charging port is required, since initially only a limited amount of current can be drawn from the first charging port. Negotiations for the first current supply from the first charging port includes making a request for more current supply from the first charging port. The first charging port is one of a plurality of the charging ports present on the current-supplying device 102 being used to charge the electronic device 104 by means of the charging device 116.

For an embodiment of the present invention, negotiations for the first current supply from the first charging port also include determining the current requirement of the electronic device 104. After the negotiation for the first current supply from the first charging port is complete, a current supply that is equivalent to the current requirement of the electronic device 104 is extracted from the first charging port.

At step 306, negotiations for a second current supply with a second charging port are initiated. The second charging port is another one of the plurality of charging ports present on the current-supplying device 102. The negotiations for the second current supply from the second charging port are based on the first current supply from the first charging port. If the first current supply is greater than a maximum current supply that can be extracted from the first charging port, negotiations for the second current supply are initiated at the second charging port. The maximum current supply of a charging port may depend on the specifications of the charging port. For an embodiment of the present invention, the second charging port can be detected by the charging device 116, based on a predefined voltage at the second charging port.

At step 308, the second current supply is combined with the first current supply to obtain a combined current supply. The combined current supply is used for charging the battery of the electronic device 104. For an embodiment, the charging condition of the charging device 116 is communicated to the electronic device 104. The charging condition of the charging device 116 is based on the combined current supply from the plurality of charging ports. The method is terminated at step 310.

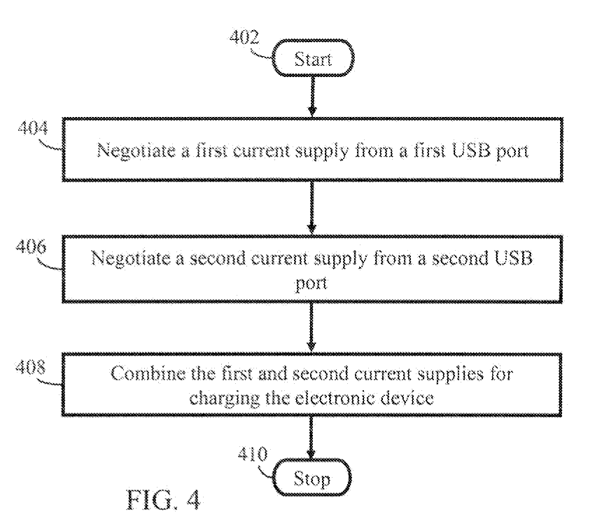

FIG. 4 is a flow diagram illustrating a method for charging the electronic device 104 by means of the charging device 102 by using a USB port, in accordance with an embodiment of the present invention. The current-supplying device 102 is used to provide current supply to the electronic device 104 through the charging device 116. The method is initiated at step 402. At step 404, negotiations for a first current supply from a first USB port are initiated. The first USB port is one of a plurality of USB ports present on the current-supplying device 102 being used to charge the battery of the electronic device 104 by means of the charging device 116.

For an embodiment of the present invention, negotiations for the first current supply from the first USB port also include determining the current requirement of the electronic device 104. After the negotiations for the first current supply from the first charging port are completed, a current supply that is equivalent to the current requirement of the electronic device 104 is extracted from the first USB port.

At step 406, negotiations for a second current supply with a second USB port is initiated. Negotiations for the second current supply from the second USB port is required since initially only a limited current can be drawn from the second USB port. Negotiations for the second current supply from the second USB port include making a request for additional current supply from the second USB port. The second USB port is one of the plurality of USB ports present on the current-supplying device 102. The negotiation for the second current supply from the second USB port is based on the first current supply from the first USB port. If the first current supply is greater than the maximum current supply that can be extracted from the first USB port, negotiations for the second current supply are initiated at the second USB port. The maximum current supply of a USB port can depend on the specifications of the USB port. For an embodiment of the present invention, the second USB port can be detected by the charging device 116, based on a predefined voltage at the second USB port.

At step 408, the second current supply is combined with the first current supply to obtain a combined current supply. The combined current supply is used for charging the battery of the electronic device 104. For an embodiment, the charging condition of the charging device 116 is communicated to the electronic device 104. The charging condition of the charging device 116 is based on the combined current supply from each of the plurality of USB ports. The method is terminated at step 410.

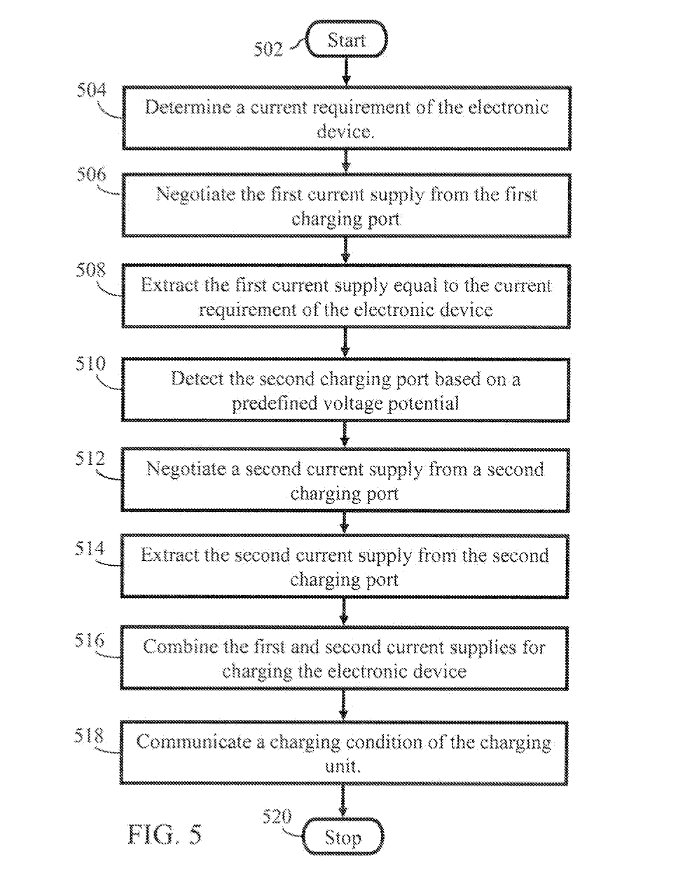

FIG. 5 is a flow diagram illustrating a detailed method for charging the electronic device by means of the charging device, in accordance with another embodiment of the present invention. It should be appreciated that although the method is described with reference to the electronic device 104 by using the charging devices 116, the method can be implemented with respect to any other electronic device 104 by using other charging devices. Further, it should be noted that the method can be implemented for a plurality of electronic devices being charged with a plurality of charging devices.

The method is initiated at step 502. At step 504, the current requirement of the electronic device 104 is determined. At step 506, the charging device 116 negotiates a first current supply from the first charging port of the current-supplying device 102. After the negotiations are completed at step 508, the first current supply, equal to the current requirement of the electronic device 104, is extracted from the first charging port. The first charging port is one of a plurality of charging ports 106, 108, 110, 112 and 114 present on the current-supplying device 102. The first current supply extracted from the first charging port can have a maximum value as per the maximum current-supplying capacity of the first charging port. The maximum current-supplying capacity can be a fraction of the current requirement of the electronic device 104. For example, typically, the maximum current-supplying capacity of a USB port is 500 mA. At step 510, a second charging port is detected by the charging device 116. The second charging port is one of the plurality of charging ports 106, 108, 110, 112 and 114 present on the current-supplying device 102. The second charging port can be detected, based on the presence of a voltage potential at one of the plurality of input connectors 202. The voltage potential at a charging port is a predefined value according to the standards associated with the type of charging port being used. For example, the voltage potential of approximately 5 volts (V) is present across the USB input connector when the USB input connector is connected to the USB port.

At step 512, a second current supply is negotiated from the second charging port. The negotiation of the second current supply depends on the first current supply that is being extracted from the first charging port. At step 514, the second current supply is extracted from the second charging port. The second current supply extracted from the second charging port complements the first current supply from the first charging port and fulfills the current requirement of the electronic device 104. At step 516, the first current supply and the second current supply are combined to obtain a combined current supply. This combined current supply is used to charge the electronic device 104. At step 518, the charging condition of the charging device 116 is communicated to the electronic device 104. The charging condition of the charging device 116 is based on the combined current supply. The charging condition can be either rapidly charging or normal charging. If the combined current supply is greater than a predefined value, the electronic device 104 is being rapidly charged. On the other hand, if the combined current supply is less than a predefined value, the electronic device 104 is being normally charged. The method is terminated at step 516.

Various embodiments of the present invention have significant advantages over the methods and systems that existed earlier. The method described in the present invention reduces the time required for charging the electronic device. Further, the electronic device can be charged by one or more charging ports simultaneously. Moreover, the present invention allows the use of multiple charging ports that are not used by other hardware appliances.

It will be appreciated that the method and system for charging electronic devices described herein may comprise one or more conventional processors and unique stored program instructions that control the one or more processors, to implement, in conjunction with certain non-processor circuits, some, most, or all of the functions of the system described herein. The non-processor circuits may include, but are not limited to, signal drivers, clock circuits, power source circuits, and user input devices. As such, these functions may be interpreted as steps of a method for charging electronic devices. Alternatively, some or all the functions could be implemented by a state machine that has no stored program instructions, or in one or more application-specific integrated circuits (ASICs), in which each function, or some combinations of certain of the functions, are implemented as custom logic. Of course, a combination of the two approaches could also be used. Thus, methods and means for these functions have been described herein.

It is expected that one with ordinary skill, notwithstanding possibly significant effort and many design choices motivated by, for example, available time, current technology and economic considerations, when guided by the concepts and principles disclosed herein, will be readily capable of generating such software instructions, programs and ICs with minimal experimentation.

In the foregoing specification, the invention and its benefits and advantages have been described with reference to specific embodiments. However, one with ordinary skill in the art would appreciate that various modifications and changes can be made without departing from the scope of the present invention, as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage or solution to occur or become more pronounced are not to be construed as critical, required, or essential features or elements of any or all the claims. The invention is defined solely by the appended claims, including any amendments made during the pendency of this application, and all equivalents of those claims, as issued.

What is claimed is:

1. A method for charging a battery of an electronic device by a charging device, the charging device being connected to a current supplying device, the current supplying device having a plurality of charging ports, the method comprising:
negotiating a first current supply from a first charging port of the plurality of charging ports at charging device;
negotiating a second current supply from a second charging port of the plurality of charging ports based on the first current supply from the first charging port; and
combining the first and second current supplies for charging the electronic device to provide a combined current supply.

2. The method as recited in claim 1, wherein negotiating the first current supply from the first charging port comprises determining a current requirement of the electronic device.

3. The method as recited in claim 2, wherein negotiating the first current supply from the first charging port further comprises extracting the first current supply equivalent to the current requirement from the first charging port.

4. The method as recited in claim 1, wherein negotiating the second current supply from the second charging port comprises detecting the second charging port based on a predefined voltage potential at the second charging port.

5. The method as recited in claim 1 further comprising communicating a charging condition of the charging device to the electronic device based on the combined current supply from each of the plurality of charging ports.

6. A method for charging a battery of an electronic device by a charging device, the charging device being connected to a current supplying device, the current supplying device having a plurality of Universal Serial Bus (USB) ports, the method comprising:
negotiating a first current supply from a first USB port of the plurality of USB ports
negotiating a second current supply from a second USB port of the plurality of USB ports based on the first current supply from the first USB port; and
combining the first and second current supplies for charging the electronic device to provide a combined current supply.

7. The method as recited in claim 6, wherein negotiating the first current supply from the first USB port comprises determining a current requirement of the electronic device.

8. The method as recited in claim 7, wherein negotiating the first current supply from the first USB port further comprises extracting the first current supply equivalent to the current requirement from the first USB port.

9. The method as recited in claim 6, wherein negotiating the second current supply from the second USB port comprises detecting the second USB port based on a predefined voltage potential at the second USB port.

10. The method as recited in claim 6 further comprising communicating a charging condition of the charging device to the electronic device based on the combined current supply from each of the plurality of USB ports.

11. A charging device for charging a battery of an electronic device, the charging device comprising:
a plurality of input connectors for connecting a current supplying device to the charging device;
a microcontroller capable of negotiating a second current supply from each one of a plurality of charging ports present in the current supplying device based on a first current supply from a first set of charging ports of the plurality of charging ports; and
an output connector for connecting the microcontroller to the electronic device, the output connector supplying a combined current supply to the electronic device by combining the first and second current supplies.

12. The charging device as recited in claim 11 further comprising an extracting module for extracting the combined current supply from the current supplying device.

13. The charging device as recited in claim 11 further comprising a detector for detecting the second charging port based on a predefined voltage potential at the second charging port.

14. The charging device as recited in claim 11 further comprising a communicating module for communicating a charging condition of the charging device to the electronic device based on the combined current supply from each of the plurality of charging ports.
